(19) United States
(12) Patent Application Publication
(10) Pub. No.: US 2024/0302067 A1
(43) Pub. Date: Sep. 12, 2024

(54) AIR PURIFIER AND CONTROL METHOD THEREFOR

(71) Applicant: SAMSUNG ELECTRONICS CO., LTD., Suwon-si Gyeonggi-do (KR)

(72) Inventors: Junhoe CHOI, Suwon-si (KR); Yongchan KWON, Suwon-si (KR); Doyoon KIM, Suwon-si (KR); Seokho JU, Suwon-si (KR); Jongsoo HONG, Suwon-si (KR)

(73) Assignee: SAMSUNG ELECTRONICS CO., LTD., Suwon-si Gyeonggi-do (KR)

(21) Appl. No.: 18/667,518

(22) Filed: May 17, 2024

Related U.S. Application Data
(63) Continuation of application No. PCT/KR2022/017248, filed on Nov. 4, 2022.

(30) Foreign Application Priority Data
Dec. 20, 2021 (KR) 10-2021-0183192

(51) Int. Cl. F24F 11/39; F24F 8/108; F24F 11/63; F24F 110/64; F24F 110/65

(52) U.S. Cl. CPC F24F 11/39; F24F 8/108; F24F 11/63; F24F 2110/64; F24F 2110/65

(57) ABSTRACT

An air purifier comprises: an inlet to suck air therethrough, an outlet to discharge the sucked air, a display; a sensor; a filter configured to filter dust from the sucked air; a fan configured to suck the air through the inlet and discharge the air filtered by the filter through the outlet; and a processor configured to identify a first variation of a concentration of dust having a first size detected by the sensor and a second variation of a concentration of dust having a second size detected by the sensor, and controls the display to display information related to filter cleaning based on a difference between the first variation and the second variation is greater than a preset value. The second size may be greater than the first size.

### CROSS-REFERENCE TO RELATED APPLICATIONS

This application is a continuation application, under 35 U.S.C. § 111(a), of International Patent Application No. PCT/KR2022/017248, filed on Nov. 4, 2022, which claims the priority benefit of Korean Patent Application No. 10-2021-0183192, filed on Dec. 20, 2021 in the Korean Patent and Trademark Office, the disclosures of which are hereby incorporated by reference in their entirety.

### TECHNICAL FIELD

This disclosure relates to an air purifier and a control method therefor. More particularly, the disclosure relates to an air purifier for purifying air and a control method therefor.

### BACKGROUND ART

An air purifier is a device for purifying air by removing dust in the air. For this, an air purifier may include a filter for removing dust or the like.

In the meantime, when a driving time of an air purifier is lengthened, a large amount of dust is accumulated in a filter, and the performance of an air purifier may be degraded.

Therefore, there is inconvenience that a user needs to clean or replace a filter and check a filter state with naked eyes to identify when the cleaning or replacement timing is.

Recently, an air purifier that estimates a state of the filter based on the driving time of an air purifier and guides the replacement and cleaning timing of the filter has been introduced to a user. However, in that the degree of contamination of air is different depending on the environments in which the filter is used, a method of simply using only the driving time has a problem that the state of the filter cannot be accurately estimated.

In another way, there is a way to estimate the filter state using a flow sensor. This method has higher accuracy than using the driving time, but there is a problem in that a manufacturing cost of the air purifier is increased, since a separate flow sensor is required.

### DISCLOSURE

### Technical Problem

The purpose of disclosure is to provide an air purifier capable of providing a user with a timing of cleaning and replacement of a filter based on a variation of dust detected by a sensor, and a control method therefor.

### Technical Solution

An air purifier includes an inlet to suck air therethrough, an outlet to discharge the sucked air, a display, a sensor, a filter configured to filter dust from the sucked air, a fan configured to suck the air through the inlet and discharge the air filtered by the filter through the outlet, and a processor configured to identify a first variation of a concentration of dust having a first size detected by the sensor and a second variation of a concentration of dust having a second size detected by the sensor, and control the display to display information related to filter cleaning, based on a difference between the first variation and the second variation being greater than a preset value, and the second size is greater than the first size.

The first variation may include a value obtained by dividing a difference between a maximum concentration and a minimum concentration of the dust having the first size detected by the sensor based on a time interval at which the maximum concentration and the minimum concentration are detected, and the second variation may include a value obtained by dividing a difference between a maximum concentration and a minimum concentration of the dust having the second size detected by the sensor based on a time interval at which the maximum concentration and the minimum concentration are detected.

The dust having the first size may be dust of 0.5 [symbol] , and the dust having the second size may be dust of 2.5 [symbol] .

In addition, the filter may include a pre-filter to remove the dust from the sucked air.

Here, the filter may further include a dust collection filter to remove dust from the air that has passed through the pre-filter.

In addition, the processor may, based on a difference between a third variation of dust concentration detected by the sensor in an initial state where the air purifier is initially driven and a fourth variation of dust concentration detected by the sensor in a state where the air purifier is driven after the first driving being greater than a preset value, and control the display to display information related to a replacement of the dust collection filter.

In addition, the third variation may include, in a state where the air purifier is initially driven, a value obtained by dividing a difference between a maximum concentration and a minimum concentration of the dust detected by the sensor based on a time interval at which the maximum concentration and the minimum concentration are detected, and the fourth variation may include, in a state where the air purifier is driven after the initial driving, a value obtained by dividing a difference between a maximum concentration and a minimum concentration of the dust detected by the sensor based on a time interval at which the maximum concentration and the minimum concentration are detected.

In the meantime, a control method of an air purifier according to an embodiment of the disclosure includes identifying a first variation of a concentration of dust having a first size detected by a sensor of the air purifier and a second variation of a concentration of dust having a second size detected by the sensor and displaying information related to cleaning of a filter of the air purifier, based on a difference between the first variation and the second variation being greater than a preset value, and the second size is greater than the first size.

Here, first variation may include a value obtained by dividing a difference between a maximum concentration and a minimum concentration of the dust having the first size detected by the sensor based on a time interval at which the maximum concentration and the minimum concentration are detected, and the second variation may include a value obtained by dividing a difference between a maximum concentration and a minimum concentration of the dust having the second size detected by the sensor based on a time interval at which the maximum concentration and the minimum concentration are detected.

In addition, the dust having the first size may be dust of 0.5 [symbol] , and the dust having the second size may be dust of 2.5 [symbol] .

In addition, the filter may include a pre-filter to remove the dust from the sucked air.

Here, the filter further may include a dust collection filter to remove the dust from the air that has passed through the pre-filter.

The method according to an embodiment may further include, based on a difference between a third variation of dust concentration detected by the sensor in an initial state where the air purifier is initially driven and a fourth variation of dust concentration detected by the sensor in a state where the air purifier is driven after the first driving being greater than a preset value, displaying information related to replacement of the dust collection filter.

Here, the third variation may include, in a state where the air purifier is initially driven, a value obtained by dividing a difference between a maximum concentration and a minimum concentration of the dust detected by the sensor based on a time interval at which the maximum concentration and the minimum concentration are detected, and the fourth variation may include, in a state where the air purifier is driven after the initial driving, a value obtained by dividing a difference between a maximum concentration and a minimum concentration of the dust detected by the sensor based on a time interval at which the maximum concentration and the minimum concentration are detected.

### Effect of Invention

According to various embodiments of the disclosure, user convenience may be improved in that an alarm for a cleaning timing of a filter may be provided to a user by using the variation in dust concentration. In addition, compared to a method for providing an alarm by simply estimating the state of a filter based on the driving time of the air purifier, the disclosure may provide more accurate information about cleaning and replacement timing of a filter, and an additional sensor is not required and thus is effective in terms of a cost.

### BRIEF DESCRIPTION OF DRAWINGS

FIG. 1 is a diagram illustrating an air clear according to an embodiment of the disclosure,

FIG. 2 is a block diagram illustrating a configuration of an air purifier according to an embodiment of the disclosure,

FIG. 3 is a view illustrating an experiment result of the amount of dust passing through a filter for each size of dust according to the amount of dust accumulated in a filter according to an embodiment of the disclosure,

FIGS. 4 and 5 are diagrams illustrating a concentration of dust sensed by a sensor according to an operation time of an air purifier according to an embodiment of the disclosure,

FIG. 6 is a diagram illustrating an example of a UI for notifying a cleaning timing of a pre-filter according to an embodiment of the disclosure,

FIGS. 7 and 8 are diagrams illustrating a concentration of dust sensed by a sensor according to an operation time of an air purifier according to an embodiment of the disclosure,

FIG. 9 is a diagram illustrating an example of a UI for notifying a replacement timing of a dust collection filter according to an embodiment of the disclosure,

FIG. 10 is a block diagram illustrating a detailed configuration of an air purifier according to an embodiment of the disclosure, and

FIG. 11 is a flowchart illustrating a control method of an air purifier according to an embodiment of the disclosure.

### MODE FOR INVENTION

Hereinafter, embodiments of the disclosure will be described with reference to the accompanying drawings. However, it may be understood that the disclosure is not limited to the embodiments described hereinafter, but also includes various modifications, equivalents, and/or alternatives of these embodiments. In relation to explanation of the drawings, similar drawing reference numerals may be used for similar constituent elements.

In the following description, a detailed description of the related art may be omitted when it is determined that such description may obscure the gist of the disclosure.

In addition, the following embodiments may be modified in many different forms, and the scope of the technical spirit of the disclosure is not limited to the following examples. Rather, these embodiments are provided so that this disclosure will be thorough and complete, and will fully convey the technical spirit to those skilled in the art.

The terms used herein are to describe certain embodiments and are not intended to limit the scope of claims. A singular expression includes a plural expression unless otherwise specified.

In the disclosure, the term “has,” “may have,” “includes” or “may include” indicates existence of a corresponding feature (e.g., a numerical value, a function, an operation, or a constituent element such as a component), but does not exclude existence of an additional feature.

In this document, the expressions “A or B,” “at least one of A and/or B,” or “one or more of A and/or B,” and the like include all possible combinations of the listed items. For example, “A or B,” “at least one of A and B,” or “at least one of A or B” includes (1) at least one A, (2) at least one B, or (3) at least one A and at least one B together.

In the disclosure, the terms “first, second, etc.” may be used to describe various elements regardless of their order and/or importance and to discriminate one element from other elements, but are not limited to the corresponding elements.

If it is described that an element (e.g., first element) is “operatively or communicatively coupled with/to” or is “connected to” another element (e.g., second element), it may be understood that the element may be connected to the other element directly or through still another element (e.g., third element).

When it is mentioned that one element (e.g., first element) is “directly coupled” with or “directly connected to” another element (e.g., second element), it may be understood that there is no element (e.g., third element) present between the element and the other element.

Herein, the expression “configured to” may be used interchangeably with, for example, “suitable for,” “having the capacity to,” “designed to,” “adapted to,” “made to,” or “capable of.” The expression “configured to” does not necessarily mean “specifically designed to” in a hardware sense.

Instead, under some circumstances, “a device configured to” may indicate that such a device can perform an action along with another device or part. For example, the expression “a processor configured to perform A, B, and C” may indicate an exclusive processor (e.g., an embedded processor) to perform the corresponding action, or a generic-purpose processor (e.g., a central processing unit (CPU) or application processor (AP)) that can perform the corresponding actions by executing one or more software programs stored in the memory device.

The term such as “module,” “unit,” “part,” and so on may refer, for example, to an element that performs at least one function or operation, and such element may be implemented as hardware or software, or a combination of hardware and software. Further, except for when each of a plurality of “modules,” “units,” “parts,” and the like needs to be realized in an individual hardware, the components may be integrated in at least one module or chip and be realized in at least one processor.

It is understood that various elements and regions in the figures may be shown out of scale. Accordingly, the scope of the disclosure is not limited by the relative sizes or spacing drawn from the accompanying drawings.

Hereinafter, with reference to the accompanying drawings, an embodiment according to the disclosure will be described in detail so that a person of ordinary skill in the art to which the disclosure pertains can easily implement the disclosure.

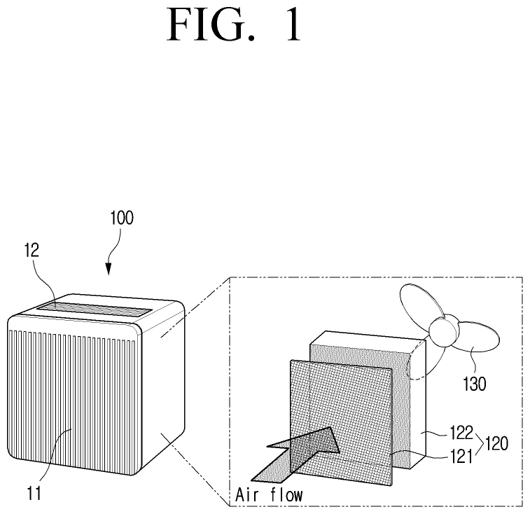

FIG. 1 is a diagram illustrating an air clear according to an embodiment of the disclosure.

Referring to FIG. 1, an air purifier 100 may purify the air by removing dust, or the like, in the air.

For this, the air purifier 100 may circulate air by driving a fan 130 and may remove dust or the like in the air through a filter 120 located on a flow path of the air.

For example, the air purifier 100 may drive the fan 130 to suck in the air through an inlet 11, remove dust or the like included in the sucked air by using the filter 120, and discharge the purified air through an outlet 12.

In this example, the filter 120 may include a pre-filter 121 and a dust collection filter 122. Accordingly, dust may be removed from the air that has passed through the filter 120 and the purified air may be discharged through the outlet 12.

According to an embodiment, the filter 120 may further include a deodorization filter (not shown). In this example, a deodorization filter (not shown) is disposed between the pre-filter 121 and the dust collection filter 122, and may remove odor particles (e.g., harmful gases such as formaldehyde, ammonia, acetic acid, etc.) contained in the air.

In the meantime, when lots of dust are accumulated in the pre-filter 121 and the dust collection filter 122, the air purifier 100 may not maintain the optimal performance.

Accordingly, the air purifier 100 according to an embodiment of the disclosure may provide an alarm related to cleaning of the pre-filter 121 and an alarm related to the replacement of the dust collection filter 122. In particular, the air purifier 100 may detect dust concentration (that is, an amount of dust) by using a sensor, and may provide an alarm based on the variation in the detected dust concentration.

Therefore, compared to a method of simply estimating the state of the filter based on the driving time of the air purifier and providing an alarm to the user, the disclosure may provide a user with more accurate information about filter cleaning and replacement timing, and an additional sensor is not required and thus, the disclosure is effective in terms of costs.

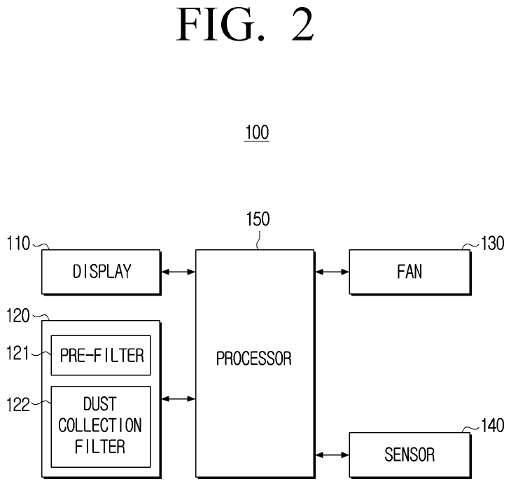

FIG. 2 is a block diagram illustrating a configuration of an air purifier according to an embodiment of the disclosure.

Referring to FIG. 2, the air purifier 100 may include a display 110, the filter 120, the fan 130, a sensor 140, and a processor 150.

The display 110 may display various screens related to the operation of the air purifier 100. For example, the display 110 may display an operation mode of the air purifier 100, detected dust concentration (for example, dust concentration such as PM 1.0, PM 2.5, PM 10, etc.), information related to cleaning and replacement of a filter, or the like.

For this, the display 110 may be implemented with various displays such as a liquid crystal display (LCD), organic light emitting diodes (OLED), or the like.

The filter 120 may filter the air sucked through the inlet of the air purifier 100. That is, the filter 120 may remove dust in the air by filtering the sucked air.

For this, the filter 120 may include the pre-filter 121 and the dust collection filter 122.

The pre-filter 121 is disposed to be adjacent to the inlet of the air purifier 100 and may collect dust having a relatively large particle in the air sucked through the inlet 11.

In addition, the dust collection filter 122 may be located behind the pre-filter 121 and may collect dust having a relatively small size, such as ultra-fine dust in the air that has passed through the pre-filter 121. In this example, the dust collection filter 122 may be implemented as an ultra-low penetration air (ULPA) filter, a high efficiency particulate filter (HEPA) filter, or the like.

The fan 130 may suck air inside the air purifier 100 and may discharge the sucked air outside the air purifier.

For this, the air purifier 100 may include a motor (not shown) for driving the fan 130. Accordingly, the fan 130 may rotate by receiving the rotational force from the motor, and the flow of air may be generated according to the driving of the fan 130.

For example, the fan 130 may include a centrifugal fan that sucks air in an axial direction and discharges the air in a radial direction. However, this is merely an example, and the fan 130 may be implemented as various types of fans.

Accordingly, dust in the air sucked through the inlet 11 is removed while passing through the filter 120, and purified air may be discharged through the outlet 12. For this, the air purifier 100 may further include a duct (not shown), and the air that has passed through the filter 120 may flow along a duct (not shown) and may be discharged to the outlet 12.

The sensor 140 may detect dust. For this, the sensor 140 may include a dust sensor.

Specifically, the sensor 140 may detect the dust concentration in a space (for example, an indoor space such as a house, an office, a restaurant, etc.) in which the air purifier 100 is located. Here, the dust concentration may be the concentration of the entire dust in the air in the space.

In addition, the sensor 140 may detect the dust concentration for each size of the dust particles. For example, the sensor 140 may detect concentrations of dust of 0.5 μm, 1 μm, 2.5 μm, 5 μm, and 10 μm, respectively.

The processor 150 controls the overall operations of the air purifier 100. The processor 150 may include a central processing unit (CPU), or the like, and may execute a software program according to at least one instruction stored in a memory (not shown) to control operations of various hardware included in the processor 150.

First, the processor 150 may drive the air purifier 100. Specifically, the processor 150 may drive the fan 130 when receiving a user command for driving the air purifier 100. Accordingly, air is sucked through the inlet 11, dust included in the sucked air is removed by the filter 120, and the air from which the dust has been removed may be discharged through the outlet 12. In addition, when a user command for setting the driving mode is received, the processor 150 may drive the fan 130 at a speed corresponding to the set driving mode. In addition, when a user command for turning off the air purifier 100 which is being driven is received, the processor 150 may stop driving of the fan 130.

As such, the processor 150 may control operations of the air purifier 100 according to various user commands.

In the meantime, the processor 150 may control the display 110 to display an alarm related to cleaning or replacement of the filter 120 based on the dust concentration variation detected through the dust sensor 120.

First, the processor 150 may control the display 110 to display an alarm related to cleaning of the pre-filter 121 based on the detected variation of dust concentration.

Specifically, the processor 150 may identify a first variation of a dust concentration of a first size detected through the sensor 140 and a second variation of a dust concentration of a second size detected through the sensor 140, and control the display 110 to display an alarm related to the cleaning of the filter 120 when the difference between the first variation and the second variation is greater than a preset value.

Here, the filter 120 may include the pre-filter 121 for removing dust from the sucked air.

In addition, the second size may be greater than the first size. For example, the dust of the first size may be dust of 0.5 μm, and the dust of the second size may be dust of 2.5 μm.

In addition, the first variation may include a value obtained by dividing a difference between a maximum dust concentration and a minimum dust concentration of a first size detected by the sensor 140 by a time interval at which a maximum concentration and a minimum concentration are detected. In addition, the second variation may include a value obtained by dividing a difference between a maximum dust concentration and a minimum dust concentration of a second size detected by the sensor 140 by a time interval at which a maximum concentration and a minimum concentration are detected.

For example, when receiving a user command to drive the air purifier 100, the processor 150 may drive the fan 130.

When the fan 130 is driven, in a process where the air inside the space in which the air purifier 100 is located is sucked and discharged to and from the air purifier 100, dust in the air may be removed by the filter 120. Accordingly, the dust amount in the air in the space where the air purifier 100 is located may gradually decrease.

In the meantime, the longer the driving time of the air purifier 100, the greater the dust amount accumulated in the filter 120.

At this time, according to the degree to which the dust is accumulated in the filter 120, the amounts of dust passing through the filter 120 may vary in accordance with the sizes of dust.

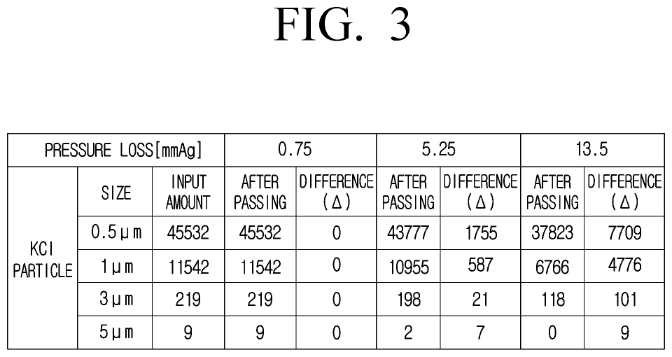

For example, FIG. 3 illustrates an experiment result about an amount of dust passing through filters for each size of dust according to an amount of dust accumulated in the filter according to an embodiment of the disclosure.

In this example, the filter may be the pre-filter 121. The pressure drop generated by the air passing through the filter is 0.75, 5.25, 13.5 [mmAg], respectively. That is, the amounts of dust accumulated in the filter may be different from each other.

In addition, dusts of 0.5 μm, 1 μm, 3 μm, and 5 μm are used, wherein the amounts of dust inserted to the pre-filter 121 for each size of dust are 45532, 11542, 219, and 9, respectively.

The pre-filter 121 performs a function of collecting relatively large dust. Accordingly, as shown in FIG. 3, in the case of dust of 0.5 μm, even if the amount of dust accumulated in the pre-filter 121 is large, approximately 80% passes through the pre-filter 121. However, in the case of dust having a relatively large size of particles, as the amount of dust accumulated in the pre-filter 121 becomes greater, the passing rate of the pre-filter 121 becomes seriously lower.

That is, as the amount of dust accumulated in the pre-filter 121 is greater, large size dust may not pass through the pre-filter 121 well, and accordingly, even if the air purifier 100 is driven, large dust is not greatly reduced in the space in which the air purifier 100 is located.

Therefore, according to an embodiment of the disclosure, an alarm related to the cleansing of the pre-filter 121 is provided by using the variation in the dust concentration of different sizes detected through the sensor 140 in consideration of the above.

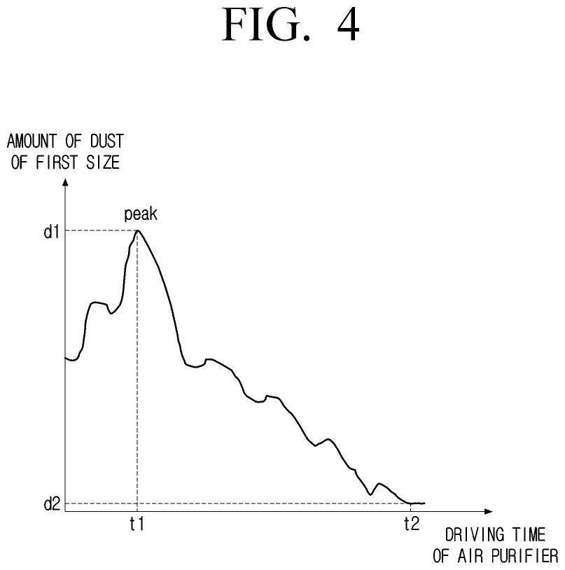

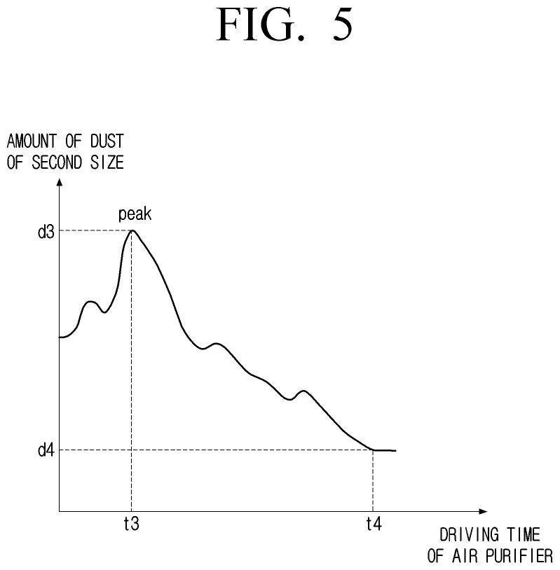

For example, FIGS. 4 and 5 are diagrams illustrating a concentration of dust sensed by the sensor 140 according to an operation time of the air purifier 100 according to an embodiment of the disclosure.

First, FIG. 4 illustrates the dust concentration of a first size detected by the sensor 140 for a predetermined time after the air purifier 100 is driven, and FIG. 5 illustrates the dust concentration of a second size detected by the sensor 140 for a predetermined time after the air purifier 100 is driven.

Here, the dust of the first size may be the dust of 0.5 [symbol] , and the dust of the second size may be dust of 2.5 [symbol] .

Referring to FIGS. 4 and 5, a dust concentration of a first size and a dust concentration of a second size may gradually increase from a point in time when dust is generated. In this example, since the air purifier 100 is being driven, these dust may be removed by the filter 120, respectively, so that the dust concentration may be gradually reduced after reaching the peak value.

Here, in the case of dust of a first size, a concentration (d1) of dust of a first size detected by the sensor 140 at a time t1 may be a maximum concentration, and a concentration (d2) of dust having a first size detected by the sensor 140 at a time t2 may be a minimum concentration.

In this example, the processor 150 may identify the variation in the dust concentration of the first size by dividing the difference (d1−d2) between the maximum concentration and the minimum concentration by the time interval (t2−t1) between the time at which the maximum concentration is detected and the time at which the minimum concentration is detected. That is, the variation of the dust concentration of the first size may be (d1−d2)/(t2−t1).

Also, in the case of dust of the second size, the concentration (d3) of the dust of the second size sensed by the sensor 140 at the time t3 may be the maximum concentration, and the concentration (d4) of the dust of the second size sensed by the sensor 140 at the time t4 may be the minimum concentration.

In this example, the processor 150 may identify the variation in the dust concentration of the second size by dividing the difference (d3-d4) between the maximum concentration and the minimum concentration by the time interval (t4-t3) between the time at which the maximum concentration is detected and the time at which the minimum concentration is detected. That is, the variation in dust concentration of the second size may be (d3-d4)/(t4-t3).

In addition, the processor 150 may compare the difference between the variations with a preset value and when the difference between the variations is greater than a predetermined value, the processor 150 may control the display 110 to display an alarm for cleaning the pre-filter 121.

Here, that the difference between the variations is greater than the predetermined value means that the speed at which large dust in the air is removed is slower than the speed at which small dust is removed, and the speeds are different from each other by a threshold value or more, and this phenomenon is due to accumulation of large amount of dust in the pre-filter 121.

Accordingly, when the difference between variations is greater than a predetermined value, the processor 150 may control the display 110 to display an alarm for cleaning of the pre-filter 121.

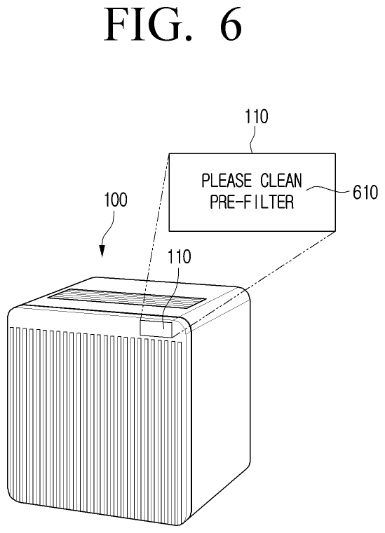

For example, as illustrated in FIG. 6, the processor 150 may display a user interface (UI) 610, on the display 110, indicating that cleaning of the pre-filter 121 is necessary, like “please clean the pre-filter”.

In the meantime, it is described that the dust of the second size is 2.5 μm in the above-described example, but this is merely an example. That is, the dust of the second size may be dust having a size of 2.5 μm or more (e.g., dust of 3 μm, 5 μm, 10 μm) as well as dust having a size of 2.5 μm.

In the meantime, the processor 150 may control the display 110 to display an alarm related to the replacement of the dust collection filter 122 based on the variation of the detected dust concentration.

Here, the dust collection filter 122 may remove dust from the air which has passed through the pre-filter 121.

To be specific, the processor 150 may, based on a difference between a third variation of dust concentration detected by the sensor in an initial state where the air purifier 100 is initially driven and a fourth variation of dust concentration detected by the sensor 140 in a state where the air purifier 100 is driven after the first driving being greater than a preset value, control the display 110 to display an alarm related to replacement of the dust collection filter 122.

Here, the dust concentration may denote entire dust concentration detected by the sensor 140.

In addition, that the air purifier 100 is initially driven may denote that, after the air purifier 100 is manufactured, the air purifier 100 is initially driven by a user.

In addition, the third variation may include, in a state where the air purifier 100 is initially driven, a value obtained by dividing a difference between a maximum concentration and a minimum concentration of dust detected by the sensor 140 by a time interval at which the maximum concentration and the minimum concentration are detected. In addition, the fourth variation may include, in a state where the air purifier 100 is driven after the initial driving, a value obtained by dividing a difference between a maximum concentration and a minimum concentration of dust detected by the sensor 140 by a time interval at which the maximum concentration and the minimum concentration are detected.

That is, in the case of the dust collection filter 122, a function of collecting dust having a size smaller than that of the pre-filter 121 is performed. Therefore, when a lot of dust is accumulated in the dust collection filter 122, unlike the pre-filter 121, the passing rate of not only large dust but also small dust for the dust collection filter 122 may be reduced.

Accordingly, according to an embodiment of the disclosure, an alarm related to the replacement of the dust collection filter 122 is provided by using the variation of the dust concentration detected through the sensor 140.

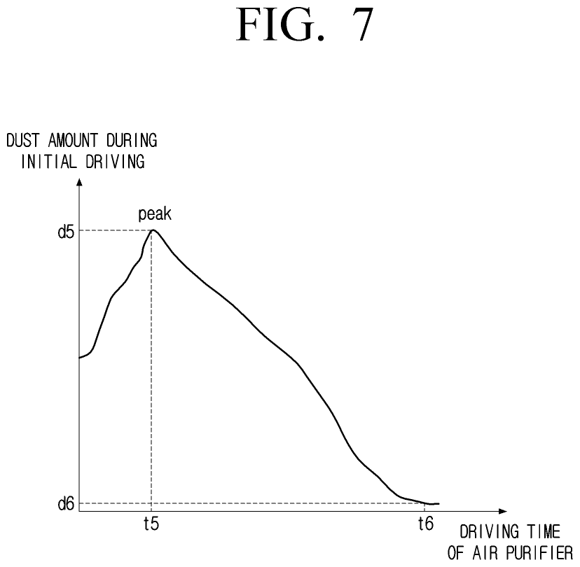

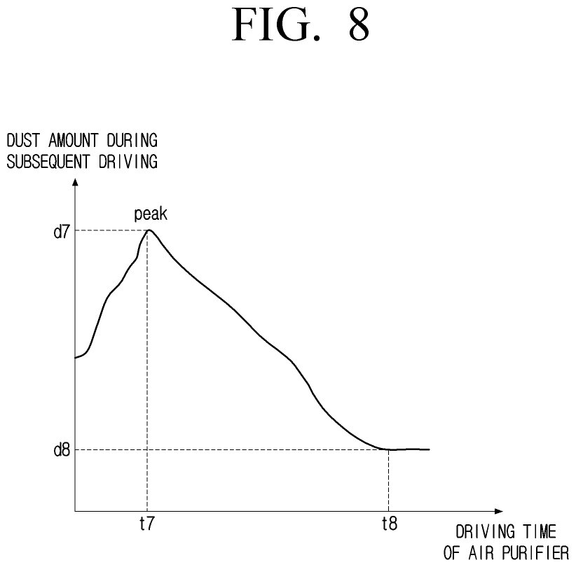

For example, FIGS. 7 and 8 are diagrams illustrating a concentration of dust sensed by the sensor 140 according to an operation time of the air purifier 100 according to an embodiment of the disclosure.

First, FIG. 7 illustrates the dust concentration detected by the sensor 140 for a predetermined time while the air purifier 100 is initially driven, and FIG. 8 illustrates the dust concentration detected by the sensor 140 for a predetermined time while the air purifier 100 is driven again after the initial operation.

At this time, it is assumed that the air purifier 100 is driven for a plurality of times or a plurality of hours in a time interval between the initial driving and the subsequent driving.

Referring to FIGS. 7 and 8, a dust concentration may gradually increase from a time when dust is generated. In this example, since the air purifier 100 is being driven, these dust may be removed by the filter 120, respectively, and accordingly, the dust concentration may be gradually reduced after reaching the peak value.

At this time, when the air purifier 100 is initially driven, a concentration (d5) of the entire dust detected by the sensor 140 at a time t5 may be a maximum concentration, and a concentration (d6) of the entire dust detected by the sensor 140 at a time t6 may be a minimum concentration.

In this example, the processor 150 may identify the variation of the entire dust concentration at the initial driving time by dividing the difference (d5-d6) between the maximum concentration and the minimum concentration by a time interval (t6-t5) between the time at which the maximum concentration is detected and the time at which the minimum concentration is detected. That is, the variation in the total dust concentration may be (d5-d6)/(t6-t5).

In addition, when the air purifier 100 is driven subsequently, the concentration (d7) of the total dust detected by the sensor 140 at the time point of t7 may be the maximum concentration, and the concentration (d8) of the total dust detected by the sensor 140 at the time point t8 may be the minimum concentration.

In this example, the processor 150 may divide the difference (d7-d8) between the maximum concentration and the minimum concentration by a time interval (t8-t7) between the time at which the maximum concentration is detected and the time at which the minimum concentration is detected, and then identify the variation in the total dust concentration at the subsequent time of driving. That is, the variation in the total dust concentration may be (d7-d8)/(t8-t7).

In addition, the processor 150 may compare the difference between the variations with a predetermined value, and when the difference between the variations is greater than a predetermined value, the processor 150 may control the display 110 to display an alarm for replacement of the dust collection filter 122.

Here, that the difference between the variations is greater than a predetermined value denotes that the speed at which dust in the air is removed is slower during the subsequent driving than the initial driving, and these speeds differ from each other by a threshold value or more, and this phenomenon is due to accumulation of a large amount of dust in the dust collection filter 122.

Accordingly, when the difference between variations is greater than a predetermined value, the processor 150 may control the display 110 to display an alarm for replacement of the dust collection filter 122.

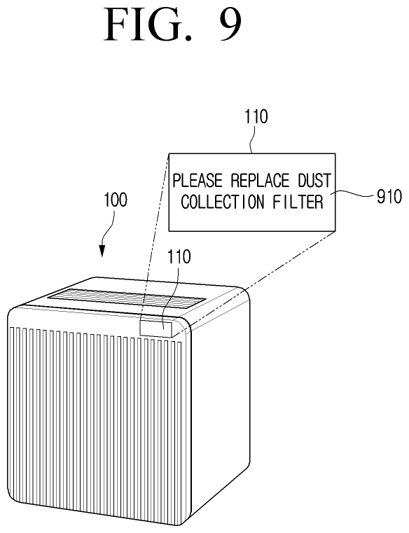

For example, as shown in FIG. 9, the processor 150 may display, on the display 110, a UI 910 indicating that replacement of the dust collection filter 122 is required, such as “please replace the dust collection filter”.

As described above, according to various embodiments, the convenience of a user may be improved in that an alarm for the cleaning timing of the pre-filter 121 and the replacement timing of the dust collection filter 122 may be provided to the user by using the dust concentration detected by the sensor 140. In addition, compared to a method for providing an alarm by simply estimating the state of a filter based on the driving time of the air purifier, the embodiment may provide a user with more accurate information about cleaning and replacement timing of a filter, and is effective in terms of cost in that an additional sensor is not required.

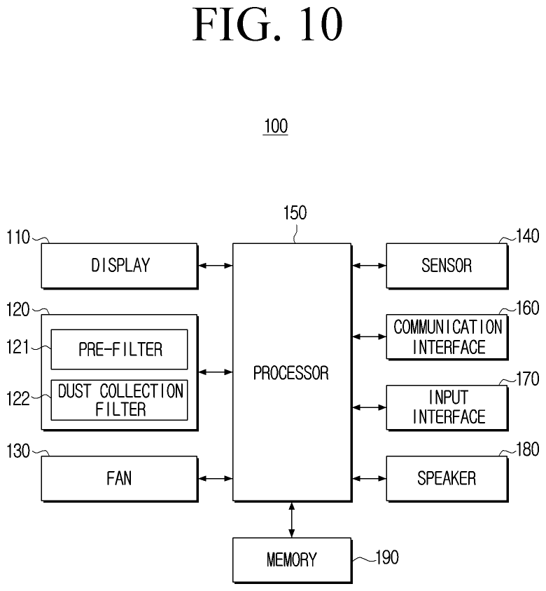

FIG. 10 is a block diagram illustrating a detailed configuration of an air purifier according to an embodiment of the disclosure.

Referring to FIG. 10, the air purifier 100 may include the display 110, the filter 120, the fan 130, the sensor 140, the processor 150, a communication interface 160, an input interface 170, a speaker 180, and a memory 190.

However, such a configuration is exemplary, and in implementing the disclosure, in addition to this configuration, a new configuration may be added or some configurations may be omitted. The display 110, the filter 120, the fan 130, the sensor 140, and the processor 150 have been described with reference to FIGS. 1 to 9. In illustrating FIG. 10, parts overlapping with the previously described parts will be omitted or abbreviated.

The communication interface 160 is configured to communicate with an external device. The processor 150 may transmit various data to an external device through the communication interface 160 and receive various data from the external device. For example, the processor 150 may receive a user command for controlling the operation of the air purifier 100 through the communication interface 160.

The communication interface 160 may perform communication with an external device through wireless communication such as Bluetooth (BT), Bluetooth low energy (BLE), WI-FI, or the like.

The input interface 170 may receive a user command. The input interface 170 may include a plurality of buttons. The input interface 170 may transfer a user command input through a plurality of buttons to the processor 150.

In the embodiments described above, the processor 150 may control the operation of the air purifier 100 based on the received user command when the user command is received through the communication interface 160 and the input interface 170.

For example, when a user command for driving the air purifier 100 is received, the processor 150 may drive the fan 130. When a user command for setting the driving mode is received, the processor 150 may drive the fan 130 at a speed corresponding to the driving mode. In addition, when a user command for turning off the air purifier 100 being driven is received, the processor 150 may stop driving of the fan 130.

As such, the processor 150 may control an operation of the air purifier 100 according to various user commands.

The speaker 180 may output audio. Specifically, the processor 150 may output various notification sounds related to the operation of the air purifier 100 or a voice guide message through the speaker 180. For example, the processor 150 may output a voice message related to cleaning of the pre-filter 121 and a voice message related to the replacement of the dust collection filter 122 through the speaker 180 based on the variation in the dust concentration detected through the sensor 140.

The memory 190 may store various data related to the operation and function of the air purifier 100. For example, at least one instruction related to the air purifier 100 may be stored in the memory 190. Various software programs or applications for operating the air purifier 100 may be stored in the memory 190 according to various embodiments of the disclosure. In addition, the memory 190 may include a volatile memory such as a frame buffer, a semiconductor memory such as a flash memory, or a magnetic storage medium such as a hard disk.

In addition, various software modules for operating the air purifier 100 may be stored in the memory 190 according to various embodiments of the disclosure, and the processor 150 may control the operation of the air purifier 100 by executing various software modules stored in the memory 190.

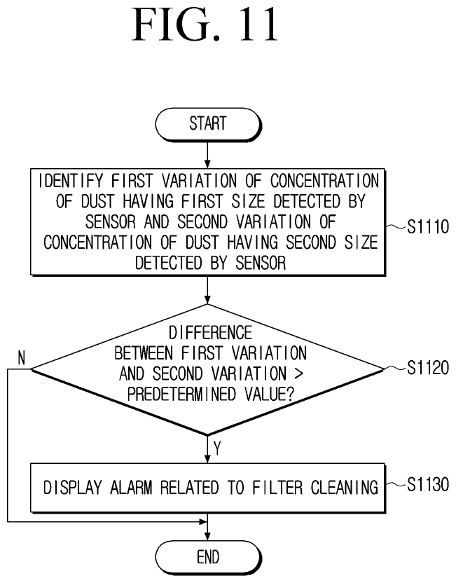

FIG. 11 is a flowchart illustrating a control method of an air purifier according to an embodiment of the disclosure.

First, a first variation of a dust concentration of a first size detected through the sensor of the air purifier and a second variation of a dust concentration of a second size detected through the sensor are identified in operation S1110. Here, the second size may be greater than the first size. For example, the dust of the first size may be 0.5 μm, and the dust of the second size may be 2.5 μm.

In addition, if the difference between the first variation and the second variation is greater than a preset value in operation S1120-Y, an alarm related to the cleaning of the filter of the air purifier is displayed in operation S1130. Here, the filter may include a pre-filter for removing dust from the sucked air.

To be specific, the first variation may include a value obtained by dividing a difference between a maximum concentration and a minimum concentration of a dust of a first size detected by the sensor by a time interval at which the maximum concentration and the minimum concentration are detected. In addition, the second variation may include a value obtained by dividing a difference between a maximum concentration and a minimum concentration of a dust of a second size detected by the sensor by a time interval at which the maximum concentration and the minimum concentration are detected.

In the meantime, the filter may further include the dust collection filter for removing dust from the air that has passed through the pre-filter.

In this example, based on a difference between a third variation of dust concentration detected by the sensor in an initial state where the air purifier is initially driven and a fourth variation of dust concentration detected by the sensor in a state where the air purifier is driven after the first driving being greater than a preset value, an alarm related to replacement of the dust collection filter may be displayed.

To be specific, the third variation may include, in a state where the air purifier is initially driven, a value obtained by dividing a difference between a maximum concentration and a minimum concentration of dust detected by the sensor by a time interval at which the maximum concentration and the minimum concentration are detected. The fourth variation may include, in a state where the air purifier is driven after the initial driving, a value obtained by dividing a difference between a maximum concentration and a minimum concentration of dust detected by the sensor by a time interval at which the maximum concentration and the minimum concentration are detected.

In the meantime, a specific method of providing an alarm for cleansing and replacement of a filter by an air purifier based on variation of dust concentration has been described.

In the meantime, a non-transitory computer readable medium in which a program for sequentially performing a method of controlling an air purifier according to the disclosure is stored may be provided.

A machine-readable storage medium may be provided in the form of a non-transitory storage medium. Herein, the term “non-transitory” only denotes that a storage medium does not include a signal (e.g., electromagnetic wave) but is tangible, and does not distinguish the case in which a data is semi-permanently stored in a storage medium from the case in which a data is temporarily stored in a storage medium. For example, “non-transitory storage medium” may refer to a buffer temporarily storing data.

According to an embodiment, the method according to various embodiments disclosed herein may be provided in a computer program product. A computer program product may be exchanged between a seller and a purchaser as a commodity. A computer program product may be distributed in the form of a machine-readable storage medium (e.g., compact disc read only memory (CD-ROM)) or distributed online through an application store (e.g., PlayStore™) directly between two user devices (e.g., smartphones). In the case of on-line distribution, at least a portion of the computer program product may be stored temporarily or at least temporarily in a storage medium such as a manufacturer's server, a server of an application store, or a memory of a relay server.

In addition, each of the components (e.g., modules or programs) according to various embodiments may include a single entity or a plurality of entities, and some sub-components of the sub-components described above may be omitted, or other sub-components may be further included in the various embodiments. Alternatively or additionally, some components (e.g., modules or programs) may be integrated into one entity to perform the same or similar functions performed by the respective components prior to the integration.

The operations performed by the module, the program, or other component, in accordance with various embodiments may be performed in a sequential, parallel, iterative, or heuristic manner, or at least some operations may be executed in a different order or omitted, or other operations may be added.

The term “unit” or “module” used in the disclosure includes units consisting of hardware, software, or firmware, and is used interchangeably with terms such as, for example, logic, logic blocks, parts, or circuits. A “unit” or “module” may be an integrally constructed component or a minimum unit or part thereof that performs one or more functions. For example, the module may be configured as an application-specific integrated circuit (ASIC).

The various example embodiments as described above may be implemented with software including instructions stored in the machine-readable storage media readable by a machine (e.g., a computer). A machine is a device which may call instructions from the storage medium and operate according to the called instructions, and may include an electronic device of the embodiments.

When the instructions are executed by a processor, the processor may perform a function corresponding to the instructions directly or by using other components under the control of the processor. The instructions may include a code generated by a compiler or a code executable by an interpreter.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An air purifier comprising:
an inlet to suck air therethrough;
an outlet to discharge the sucked air;
a display;
a sensor;
a filter configured to filter dust from the sucked air;
a fan configured to suck the air through the inlet, and discharge the air filtered by the filter through the outlet; and
a processor configured to:
identify a first variation of a concentration of dust having a first size detected by the sensor and a second variation of a concentration of dust having a second size detected by the sensor; and
control the display to display information related to filter cleaning, based on a difference between the first variation and the second variation being greater than a preset value,
wherein the second size is greater than the first size.

2. The air purifier of claim 1, wherein the first variation comprises a value obtained by dividing a difference between a maximum concentration and a minimum concentration of the dust having the first size detected by the sensor based on a time interval at which the maximum concentration and the minimum concentration are detected, and
wherein the second variation comprises a value obtained by dividing a difference between a maximum concentration and a minimum concentration of the dust having the second size detected by the sensor based on a time interval at which the maximum concentration and the minimum concentration are detected.

3. The air purifier of claim 1, wherein:
the dust having the first size is dust of 0.5 [symbol] , and
the dust having the second size is dust of 2.5 [symbol] .

4. The air purifier of claim 1, wherein the filter comprises a pre-filter to remove the dust from the sucked air.

5. The air purifier of claim 4, wherein the filter further comprises a dust collection filter to remove the dust from the air that has passed through the pre-filter.

6. The air purifier of claim 5, wherein the processor is further configured to:
based on a difference between a third variation of dust concentration detected by the sensor in an initial state where the air purifier is initially driven and a fourth variation of dust concentration detected by the sensor in a state where the air purifier is driven after the first driving being greater than a preset value and
control the display to display information related to a replacement of the dust collection filter.

7. The air purifier of claim 6, wherein:
the third variation comprises, in a state where the air purifier is initially driven, a value obtained by dividing a difference between a maximum concentration and a minimum concentration of the dust detected by the sensor based on a time interval at which the maximum concentration and the minimum concentration are detected, and
the fourth variation comprises, in a state where the air purifier is driven after the initial driving, a value obtained by dividing a difference between a maximum concentration and a minimum concentration of the dust detected by the sensor based on a time interval at which the maximum concentration and the minimum concentration are detected.

8. A control method of an air purifier, the method comprising:
identifying a first variation of a concentration of dust having a first size detected by a sensor of the air purifier and a second variation of a concentration of dust having a second size detected by the sensor; and
displaying information related to cleaning of a filter of the air purifier, based on a difference between the first variation and the second variation being greater than a preset value,
wherein the second size is greater than the first size.

9. The method of claim 8, wherein the first variation comprises a value obtained by dividing a difference between a maximum concentration and a minimum concentration of the dust having the first size detected by the sensor based on a time interval at which the maximum concentration and the minimum concentration are detected, and
wherein the second variation comprises a value obtained by dividing a difference between a maximum concentration and a minimum concentration of the dust having the second size detected by the sensor based on a time interval at which the maximum concentration and the minimum concentration are detected.

10. The method of claim 8, wherein:
the dust having the first size is dust of 0.5 [symbol] , and
the dust having the second size is dust of 2.5 [symbol] .

11. The method of claim 8, wherein the filter comprises a pre-filter to remove the dust from the sucked air.

12. The method of claim 11, wherein the filter further comprises a dust collection filter to remove the dust from the air that has passed through the pre-filter.

13. The method of claim 12, further comprising:
based on a difference between a third variation of dust concentration detected by the sensor in an initial state where the air purifier is initially driven and a fourth variation of dust concentration detected by the sensor in a state where the air purifier is driven after the first driving being greater than a preset value, displaying information related to a replacement of the dust collection filter.

14. The method of claim 13, wherein:
the third variation comprises, in a state where the air purifier is initially driven, a value obtained by dividing a difference between a maximum concentration and a minimum concentration of the dust detected by the sensor based on a time interval at which the maximum concentration and the minimum concentration are detected, and
the fourth variation comprises, in a state where the air purifier is driven after the initial driving, a value obtained by dividing a difference between a maximum concentration and a minimum concentration of dust detected by the sensor based on a time interval at which the maximum concentration and the minimum concentration are detected.

15. A non-transitory computer readable recording medium storing computer instructions that cause an air purifier to perform an operation when executed by a processor of the air purifier, wherein the operation comprises:
identifying a first variation of a concentration of dust having a first size detected by a sensor of the air purifier and a second variation of a concentration of dust having a second size detected by the sensor; and
displaying information related to cleaning of a filter of the air purifier, based on a difference between the first variation and the second variation being greater than a preset value,
wherein the second size is greater than the first size.

16. The non-transitory computer readable recording medium of claim 15, wherein the first variation comprises a value obtained by dividing a difference between a maximum concentration and a minimum concentration of the dust having the first size detected by the sensor based on a time interval at which the maximum concentration and the minimum concentration are detected, and
wherein the second variation comprises a value obtained by dividing a difference between a maximum concentration and a minimum concentration of the dust having the second size detected by the sensor based on a time interval at which the maximum concentration and the minimum concentration are detected.

17. The non-transitory computer readable recording medium of claim 15, wherein:
the dust having the first size is dust of 0.5 [symbol] , and
the dust having the second size is dust of 2.5 [symbol] .

18. The non-transitory computer readable recording medium of claim 15, wherein the filter comprises a pre-filter to remove the dust from the sucked air.

19. The non-transitory computer readable recording medium of claim 18, wherein the filter further comprises a dust collection filter to remove the dust from the air that has passed through the pre-filter.

20. The non-transitory computer readable recording medium of claim 19, further comprising:
based on a difference between a third variation of dust concentration detected by the sensor in an initial state where the air purifier is initially driven and a fourth variation of dust concentration detected by the sensor in a state where the air purifier is driven after the first driving being greater than a preset value, displaying information related to a replacement of the dust collection filter.
